(19) United States
(12) Patent Application Publication
(10) Pub. No.: US 2025/0043773 A1
(43) Pub. Date: Feb. 6, 2025

(54) WIND TURBINE BLADE HAVING AN ELECTRO-THERMAL SYSTEM

(71) Applicant: LM WIND POWER A/S, Kolding (DK)

(72) Inventors: Isaac TOVAR, Kolding (DK); Allan HANSEN, Kolding (DK); Rajamanohari DEVARAJ, Kolding (DK); Victor MIRANDA, Kolding (DK); Lars Bo HANSEN, Kolding (DK); Peter BENTSEN, Kolding (DK)

(21) Appl. No.: 18/576,731

(22) PCT Filed: Jul. 5, 2022
(86) PCT No.: PCT/EP2022/068557

§ 371 Date: Jan. 4, 2024

(30) Foreign Application Priority Data
Jul. 6, 2021 (EP) 21184064.0

(51) Int. Cl. F03D 80/40; F03D 80/00; F03D 80/30

(52) U.S. Cl. CPC F03D 80/401; B29C 70/885; F03D 1/0675; F03D 80/003; F03D 80/30; B29D 99/0025; B29L 2031/085; F03D 1/0688; F05B 2240/303; F05B 2280/50

(57) ABSTRACT

A wind turbine blade comprising:
an aerodynamic shell body with a suction side shell part and a pressure side shell part that extends in a longitudinal direction between a root and a tip and in a transverse direction between a leading edge and a trailing edge, and
an electro-thermal system for mitigating ice formation on the wind turbine blade, the electro-thermal system comprising:
   a heating layer comprising electrically conductive fibres arranged to extend substantially in a longitudinal section of the aerodynamic shell body, wherein the electrically conductive fibres of the heating layer are configured for, upon receiving electrical power from a power cable, supplying resistive heating to an exterior side of the wind turbine blade so as to mitigate ice formation on the wind turbine blade;
   a metallic lightning protection layer arranged exteriorly to and overlapping the heating layer; and
   a down conductor being electrically connected to the metallic lightning protection layer so as to conduct a lightning strike current from the metallic lightning protection layer to the first end of the down conductor;
wherein the heating layer and the metallic lightning protection layer are embedded in and co-infused with the aerodynamic shell body.

### TECHNICAL FIELD

The present invention relates to a wind turbine blade having an electro-thermal system.

### BACKGROUND

When wind turbines are operated in cold-weather climates, the potential build-up of ice on the wind turbine blades presents challenges for turbine performance. In a first aspect, any ice formation on the blade surfaces will disrupt the blade aerodynamics, which may lead to a reduction in turbine efficiency and/or increased operational noise levels. In a further aspect, ice which breaks away from blade surfaces can present a falling hazard. In this regard, wind turbine blades in such locations are often provided with systems to deliver ice prevention and/or removal.

It is known to provide hot-air electro-thermal systems which operate on the principle of supplying heated air to the interior of a wind turbine blade to raise the surface temperature of the blade to above freezing. An example of such a hot-air electro-thermal system can be seen in US Patent Application Publication No. US 2013/0106108.

It is also known to utilise electrical heating systems embedded in blades and mechanical electro-thermal systems. However, including conductive materials in the blade comes with the risk of a lightning strike attaching to these conductive materials. Especially, when the conductive materials are included near the tip of the blade as this region of the blade is at high risk of lightning strikes.

For electrical heating systems there is a need for lightning protection with reduced surface disturbance to avoid reducing annual energy production. Accordingly, there is a need for new solutions.

### SUMMARY

On this background, it may be seen as an object of the present disclosure to provide a wind turbine blade having an electro-thermal system which overcomes or ameliorates at least one of the disadvantages of the prior art or which provides a useful alternative.

One or more of these objects may be met by aspects of the present disclosure as described in the following.

A first aspect of this disclosure relates to a wind turbine blade comprising:
an aerodynamic shell body with a suction side shell part and a pressure side shell part that extends in a longitudinal direction between a root and a tip and in a transverse direction between a leading edge and a trailing edge, and
an electro-thermal system for mitigating ice formation on the wind turbine blade, the electro-thermal system comprising:
   a heating layer comprising electrically conductive fibres arranged to extend substantially in a longitudinal section, preferably a leading edge section, of the aerodynamic shell body;
   a power cable configured for supplying power to the heating layer and configured for being connected to a power source, wherein the electrically conductive fibres of the heating layer are configured for, upon receiving electrical power from the power cable, supplying resistive heating to an exterior side of the wind turbine blade so as to mitigate, such as to melt or prevent, ice formation on the wind turbine blade;
   a metallic lightning protection layer arranged exteriorly to and overlapping the heating layer, the metallic lightning protection layer being configured for receiving a lightning strike; and
   a down conductor having a first end arranged at the root of the wind turbine blade configured for being earthed, the down conductor being electrically connected to the metallic lightning protection layer so as to conduct a lightning strike current from the metallic lightning protection layer to the first end of the down conductor;
wherein the heating layer, preferably the electrically conductive fibres of the heating layer, and the metallic lightning protection layer are embedded in and co-infused with the aerodynamic shell body.

Embedding and co-infusing the heating layer and the metallic lightning protection layer with the aerodynamic shell body may provide a smoother exterior surface for improved aerodynamic performance, especially when compared to arrangement wherein the heating layers and/or metallic lightning protection layers are overlaminated onto the aerodynamic shell body. In addition, arranging the metallic lightning protection layer exteriorly and overlapping the heating layer may reduce the risk of a lightning strike flashing to the heating layer.

Additionally or alternatively, the metallic lightning protection layer may be a metallic mesh, preferably a copper mesh, e.g. an expanded copper mesh or perforated copper mesh.

Additionally or alternatively, the electrically conductive fibres may be carbon fibres. The electrically conductive fibres may be arranged in one or more fibre layers, preferably biaxial. The fibre layers may be non-woven and/or may be arranged at +/−45 degrees relative to the longitudinal direction.

Additionally or alternatively, the power cable may comprise a first power conductor connected to a root side portion of the heating layer at the root side edge of the heating layer, and a second power conductor connected to a tip side portion of the heating layer at the tip side edge of the heating layer, the root side portion being closer to the root of the wind turbine than the tip side portion.

In the context of the present disclosure, when two parts are “co-infused” it is understood that both parts are simultaneously infused with a resin and cured in the same process. Thus, co-infusing two fibre-reinforced parts, such as the heating layer and the aerodynamic shell body of the wind turbine blade, involves arranging dry fibres of the two fibre-reinforced parts in a mould, infusing them simultaneously in the same process with a resin, and causing or letting the resin cure. This contrasts with a process wherein two separately manufactured parts which is joined or a process of overlaminating one part onto another part.

Additionally or alternatively, the electro-thermal system may comprise an electrical insulation layer interposed between the metallic lightning protection layer and the heating layer, the electrical insulation layer may be configured for preventing a lightning strike flashing to the heating layer and may preferably be made of polyethylene terephthalate (PET), e.g. a PET film. The electrical insulation layer may be embedded in and co-infused with the aerodynamic shell body.

By interposing an electrical insulation layer between the heating layer and the metallic lightning protection layer, the risk of damage to the heating layer in the event of lightning strike is reduced while also reducing the risk of a short circuit to the metallic lightning protection layer during operation of the electro-thermal system for mitigating ice formation on the wind turbine blade.

The electrical insulation layer may be configured for preventing a lightning strike flashing to the heating layer by selecting the material of the electrical insulation layer and the relative positioning of the electrical insulation layer relative to the heating layer and the metallic lightning protection layer so that a flashover voltage required for flashing over an end of the metallic lightning protection layer to a corresponding end of the heating layer is greater than a puncture voltage required for the lightning strike to puncture through the electrical insulation layer. The flashover voltage and puncture voltage can for instance be obtained by experiments.

Additionally, the electrical insulation layer may comprise a laminate structure including a polymer film, e.g. a PET film, sandwiched between two fibre layers, preferably glass fibres layers. The laminate structure may be prefabricated prior to infusion and curing of the heating layer, the metallic lightning protection layer, and optionally the electrical insulation layer. The laminate structure may comprise an adhesive bonding the polymer film to the fibre layers. The adhesive is preferably different from the resin used to cure the heating layer, the metallic lightning protection layer, and optionally the electrical insulation layer.

Additionally or alternatively, the heating layer may comprise a root side edge, a tip side edge, a longitudinal suction side edge, and a longitudinal pressure side edge. The metallic lightning protection layer may comprise a root side edge, a tip side edge, a longitudinal suction side edge, and a longitudinal pressure side edge. The tip edge side of the metallic lightning protection layer may be positioned beyond the tip edge side of the heating layer towards the tip of the wind turbine blade and may be arranged with a longitudinal gap to the tip edge side of the heating layer.

This may provide the advantage of further reducing the risk of a lightning strike near the tip of the wind turbine blade flashing onto the heating layer instead of the metallic lightning protection layer.

Additionally or alternatively, the electrical insulation layer may comprise a root side edge, a tip side edge, a longitudinal suction side edge, and a longitudinal pressure side edge. The longitudinal suction and pressure side edges of the electrical insulation layer may extend beyond, e.g. further towards the trailing edge, both the longitudinal suction side edge and the longitudinal pressure side edge of the heating layer.

Additionally or alternatively, the edges of the heating layer, the metallic lightning protection layer, and the electrical insulation layer may be identified as follows. The root side edge may be located closest to the root and the tip side edge may be located closest to the tip. The longitudinal suction side edge and longitudinal pressure side edge may extend substantially along the longitudinal direction. The longitudinal suction side edge may be located in the suction side shell part and the longitudinal pressure side edge may be located in the pressure side shell part. Further, the longitudinal suction and pressure side edges are the outermost longitudinal edges, e.g. closest to the trailing edge.

Additionally, the longitudinal suction side edge of the electrical insulation layer may extend beyond a line or plane intersecting the longitudinal suction side edge of the heating layer and the longitudinal suction side edge of the metallic lightning protection layer. The longitudinal pressure side edge of the electrical insulation layer may extend beyond a line or plane intersecting the longitudinal pressure side edge of the heating layer and the longitudinal pressure side edge of the metallic lightning protection layer.

Additionally or alternatively, the aerodynamic shell body may comprise a longitudinally extending bond line between the suction side shell part and the pressure side shell part at the leading edge, the bond line dividing the heating layer into a first heating layer part and a second heating layer part, the metallic lightning protection layer into a first metallic lightning protection layer part and a second metallic lightning protection part, and preferably the electrical insulation layer into a first electrical insulation layer part and a second electrical insulation layer part. The first heating layer part and/or the first metallic lightning protection layer part may be embedded in and co-infused with the suction side shell part. The second heating layer part and/or the second metallic lightning protection layer part may be embedded in and co-infused with the pressure side shell part.

Additionally, the electro-thermal system may comprise a leading edge insulation layer made of an electrically insulating polymer material, preferably a PET film. The leading edge insulation layer may extend along and overlap the bond line at the leading edge. The leading edge insulation layer may extend transversely from the bond line and overlap the first and second metallic lightning protection layer parts along a circumference of the suction side shell part and the pressure side shell part.

By including a leading edge insulation layer, the risk of a lightning strike on the bond line puncturing through to the ends of heating layer parts adjacent to the bond line is reduced.

Additionally or alternatively, the heating layer may comprise an additional carbon fibre mat arranged adjacent to the bond line. This may ensure adequate heat is supplied at the bond line to mitigate ice formation.

Additionally or alternatively, the aerodynamic shell body may comprise a leading edge protection cap overlapping the bond line and preferably overlapping the leading edge insulation layer. The leading edge protection cap may have an exterior side exposed to the exterior of the wind turbine blade and may be configured for providing erosion resistance to the leading edge of the wind turbine blade. The leading edge protection cap may preferably comprise or consist essentially of polyurethane (PUR).

Additionally or alternatively, the electro-thermal system may comprise a first exterior layer covering the metallic lightning protection layer. The first exterior layer may have an interior side covering the metallic lightning protection layer and may have an exterior side exposed to the exterior of the wind turbine blade. The first exterior layer may preferably comprise a paint, such as a polyurethane (PUR) paint, and/or a veil, such as a polyester-based veil. The first exterior layer may preferably be at most 0.8 mm thick, more preferably in the range of 0.1-0.4 mm, even more preferably 0.2-0.3 mm.

By covering the metallic lightning protection layer by the first exterior layer, erosion of the metallic lightning protection layers may be reduced. Further, providing the first exterior layer sufficiently thin may reduce the risk of a lightning strike flashing over the surface of the first exterior layer instead of through the first exterior layer to the metallic lightning protection layer.

Additionally or alternatively, the aerodynamic shell body may comprise a second exterior layer that may have an exterior side exposed to the exterior of the wind turbine blade. The second exterior layer may be substantially flush with the first exterior layer and may be different from the first exterior layer. The second exterior layer may preferably be a gelcoat, preferably a polyester-based gelcoat.

Additionally or alternatively, the second exterior layer may not cover at least the metallic lightning protection layer, and/or the remaining parts of the aerodynamic shell body.

Additionally or alternatively, the electro-thermal system may comprise a number of cable clamp devices including at least a first cable clamp device. The number of cable clamp devices may electrically connect the power cable and the down conductor to form an equipotential bonding connection at distinct longitudinal positions along the longitudinal direction between the root and the tip of the blade.

The cable clamps may advantageously provide an equipotential bonding connection between the power cable and the lightning cable to reduce or avoid any flashover in the event of a lightning strike attaching the blade and consequently reducing or even avoiding blade damage.

Additionally or alternatively, the power cable comprises a shielding and wherein the number of cable clamp devices are electrically connected to the shielding of the power cable.

Additionally or alternatively, the number of cable clamp devices may each comprise a housing and a metallic clamp part. Each metallic clamp part may receive and clamp the down conductor and the power cable, preferably the shielding of the power cable, to form an equipotential bonding connection. The housing may surround the metallic clamp part so as to electrically insulate the metallic clamp part and the equipotential bonding connection. The housing may comprise through holes accommodating the down conductor and the power cable. The housing may preferably be made of a polymer, such as polyurethane (PUR).

Additionally or alternatively, the electro-thermal system may comprise a number of surge protection devices including one or more first surge protection devices and/or one or more second surge protection devices and/or one or more third surge protection devices. The first surge protection devices may be connected to the heating layer and to the down conductor. The second surge protection devices may be connected to the heating layer and the metallic lightning protection layer.

The third surge protection devices may be connected to the down conductor and the power cable.

Additionally or alternatively, the electro-thermal system may comprise a number of temperature sensors including at least one exterior temperature sensor configured for sensing an exterior temperature of the wind turbine blade and/or at least one interior temperature sensor configured for sensing an interior temperature of the wind turbine blade.

Additionally or alternatively, the number of temperature sensors may be configured for providing temperature signals to a control device that may be arranged in the hub of the wind turbine. The control device may control the power supply to the heating layer based on the temperature signals from the number of temperature sensors so as to mitigate ice formation on the wind turbine blade.

The number of temperature sensors may be fibre-optic.

Additionally or alternatively, the electro-thermal system may comprise a tip receptor arranged at the tip of the wind turbine blade and configured for receiving a lightning strike, the tip receptor being electrically connected to the down conductor.

A second aspect of the present disclosure relates to a method of manufacturing an aerodynamic shell body for a wind turbine blade, preferably according to the first aspect of this disclosure. The method comprising the steps of laying up a heating layer comprising electrically conductive fibres, a metallic lightning protection layer, and an electrical insulation layer together with one or more shell layers of the aerodynamic shell body as dry layers (i.e. non-cured layers, e.g. only the fibres without resin) and subsequently co-infusing and curing the layers in a single vacuum assisted resin transfer moulding process so as to embed the heating layer, the metallic lightning protection layer, and the electrical insulation layer in an aerodynamic shell body.

A person skilled in the art will appreciate that any one or more of the above aspects of this disclosure and embodiments thereof may be combined with any one or more of the other aspects of this disclosure and embodiments thereof.

### BRIEF DESCRIPTION OF THE DRAWINGS

Embodiments of this disclosure will be described in more detail in the following with regard to the accompanying figures. The figures show one way of implementing the present invention and are not to be construed as being limiting to other possible embodiments falling within the scope of the attached claim set.

FIG. 1 is a schematic perspective view of a wind turbine.

FIG. 2 is a schematic perspective view of a wind turbine blade having a longitudinal leading edge section for a wind turbine as shown in FIG. 1.

FIG. 3 is a schematic illustration along a longitudinal direction of an electro-thermal system incorporated into the longitudinal section of the wind turbine blade as shown in FIG. 2.

FIG. 4 is a schematic cross-sectional view of the longitudinal section of the wind turbine blade as shown in FIG. 2.

FIG. 5A-5C are schematic views of a cable clamp device.

### DETAILED DESCRIPTION OF THE INVENTION

In the following figure description, the same reference numbers refer to the same elements and may thus not be described in relation to all figures.

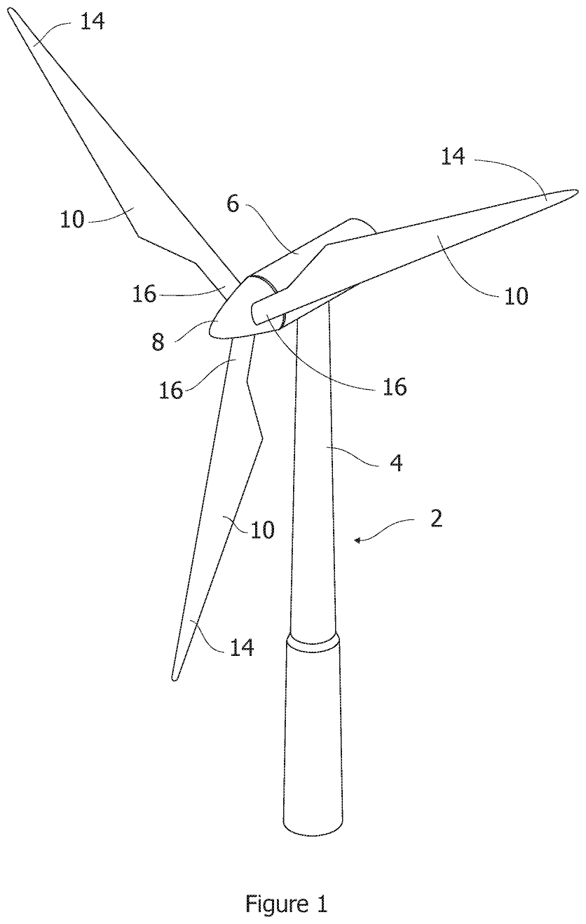

FIG. 1 illustrates a conventional modern upwind wind turbine 2 according to the so-called “Danish concept” with a tower 4, a nacelle 6 and a rotor with a substantially horizontal rotor shaft which may include a tilt angle of a few degrees. The rotor includes a hub 8 and three blades 10 extending radially from the hub 8, each having a blade root 16 nearest the hub and a blade tip 14 furthest from the hub 8.

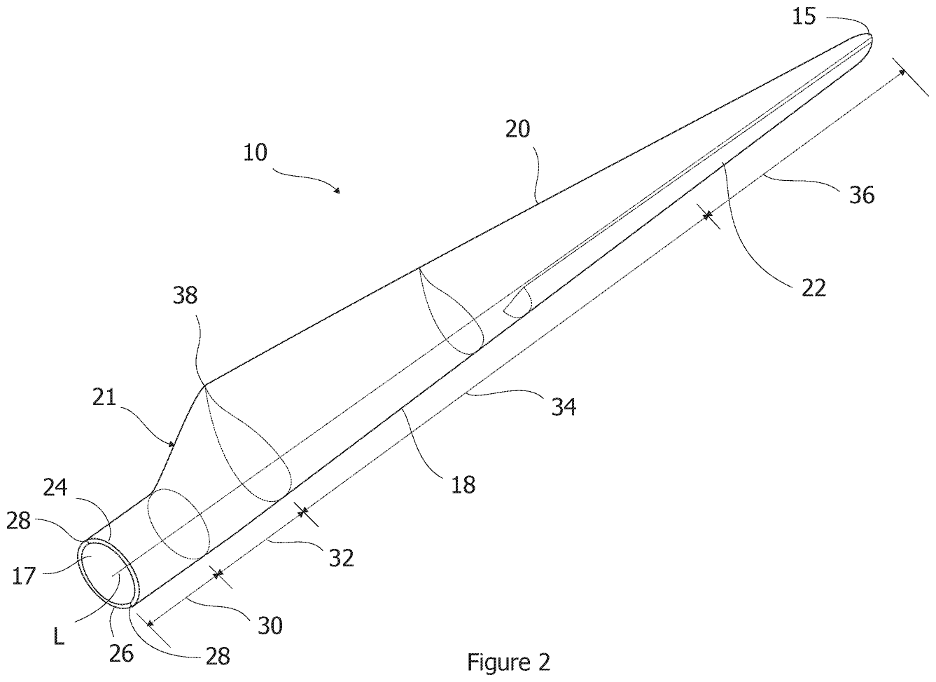

FIG. 2 shows a schematic view of an exemplary wind turbine blade 10. The wind turbine blade 10 has the shape of a conventional wind turbine blade with a root end 17 and a tip end 15 and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub 8, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root region 30. The transition region 32 has a transitional profile gradually changing from the circular or elliptical shape of the root region 30 to the airfoil profile of the airfoil region 34. The chord length of the transition region 32 typically increases with increasing distance r from the hub.

The airfoil region 34 has an airfoil profile with a chord extending between the leading edge 18 and the trailing edge 20 of the blade 10. The width of the chord decreases with increasing distance r from the hub.

A shoulder 38 of the blade 10 is defined as the position, where the blade 10 has its largest chord length. The shoulder 38 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade 10 is typically made from a pressure side shell part 24 and a suction side shell part 26 that are glued to each other along bond lines 28 at the leading edge 18 and the trailing edge 20 of the blade to form an aerodynamic shell body 21 of the wind turbine blade 10.

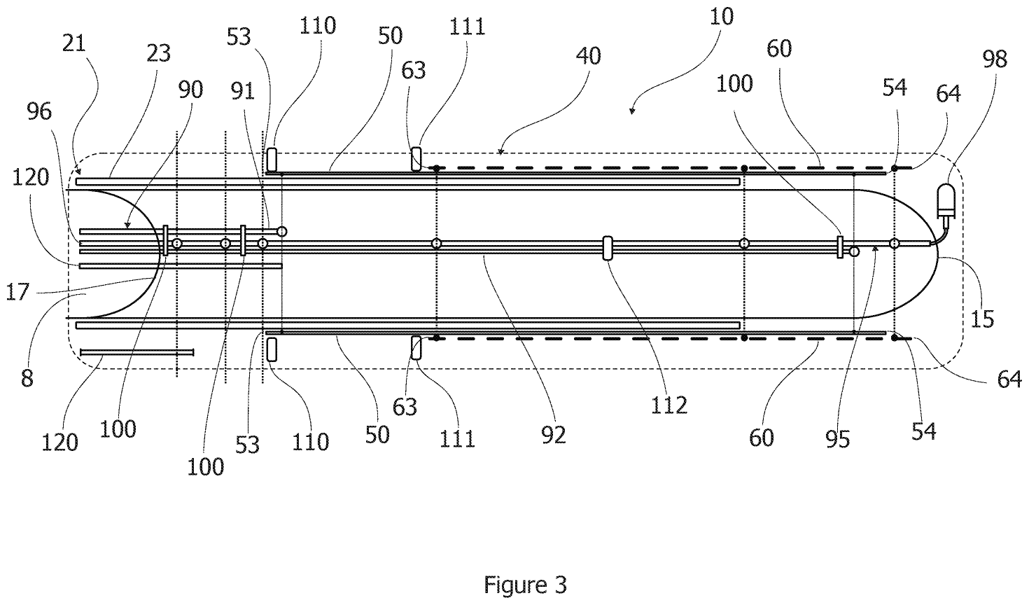

Turning to FIG. 3, electrical connections and the laminate structure of an electro-thermal system 40 incorporated in such an aerodynamic shell body 21 of the blade 10 are schematically illustrated. The electro-thermal system 40 is intended to mitigate, e.g. by preventing or melting, ice formation in the leading edge section 22 of the wind turbine blade as shown in FIG. 2.

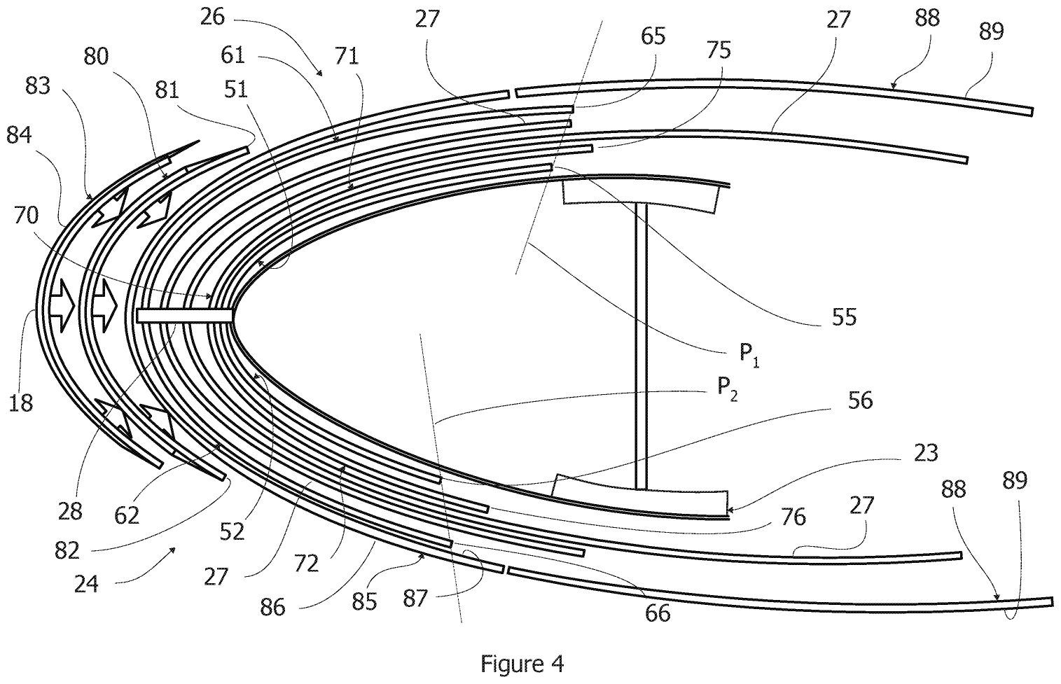

As best seen in FIG. 3, the electro-thermal system 40 comprises a heating layer 50. In the present embodiment, the heating layer 50 comprises a non-woven biaxial carbon fibre mat arranged to extend substantially in the leading edge section 22 (shown in FIG. 2) and is oriented at +/−45 degrees relative to the longitudinal direction. However, other arrangements of the heating layer 50 may be employed. The heating layer 50 comprises a root side edge 53 and a tip side edge 54. As best seen in FIG. 4, the heating layer 50 further comprises a longitudinal suction side edge 55 and a longitudinal pressure side edge 56. In the following, the edges of the heating layer, the metallic lightning protection layer, and the electrical insulation layer may be identified as follows. The root side and tip side edges extend substantially in a transverse direction to the longitudinal direction, e.g. a chordwise direction, while the longitudinal suction and pressure side edges extend substantially in the longitudinal direction. The root side edge is located closest to the root and the tip side edge is located closest to the tip. The longitudinal suction side edge is located in the suction side shell part 26 and the longitudinal pressure side edge may be located in the pressure side shell part 24. Further, the longitudinal suction and pressure side edges are the outermost longitudinal edges, e.g. closest to the trailing edge.

Returning to FIG. 3, the electro-thermal system 50 also comprises a metallic lightning protection layer 60 configured for receiving a lightning strike. In the present embodiment, the metallic lightning protection layer 60 is in the form of an expanded or perforated copper mesh. The metallic lightning protection layer 60 is arranged exteriorly to and overlaps the heating layer 50 and thus reduces the risk of the lightning strike flashing to the heating layer 50. The metallic lightning protection layer 60 comprises a root side edge 63 and a tip side edge 64. As best seen in FIG. 4, the metallic lightning protection layer 60 further comprises a longitudinal suction side edge 65 and a longitudinal pressure side edge 66. As best seen in FIG. 3, the tip edge side 64 of the metallic lightning protection layer 60 is positioned beyond the tip edge side 53 of the heating layer 50 towards the tip of the wind turbine blade and is arranged with a longitudinal gap to the tip edge side 53 of the heating layer 50.

The electro-thermal system 50 further comprises a power cable 90 including a first power conductor 91 and a second power conductor 92. The first conductor 91 is electrically connected to a root side portion of the heating layer 50 and the second power conductor 92 is electrically connected to a tip side portion of the heating layer 50. The root side portion is closer to the root of the wind turbine than the tip side portion. A root end of the power cable 90 is configured for being connected to a power source which could for instance be located in the hub 8 or in the blade 10. Accordingly, the power cable 90 can supply power to the heating layer 50. The electrically conductive carbon fibres of the heating layer 50 can thus, upon receiving electrical power from the power cable 90, supply resistive heating to an exterior side of leading edge section 22 of the wind turbine blade 10 and thus mitigate, e.g. by melting or preventing, ice formation on the wind turbine blade 10.

The electro-thermal system 50 includes a down conductor 95 that has a first end 96 arranged at the root of the wind turbine blade 10. The first end 96 is configured for being earthed via a down conductor of the hub 8. The down conductor 95 is electrically connected to the metallic lightning protection layer so as to conduct a lightning strike current from the metallic lightning protection layer 60 to the first end of the down conductor 95. An opposite end of the down conductor 95 at the tip end 15 of the wind turbine blade 10 is electrically connected to a tip receptor 98 of the electro-thermal system 40 configured for receiving a lightning strike at the tip 15.

Turning to FIG. 4, the electric-thermal system 40 comprises an electrical insulation layer 70 (omitted on FIG. 3) configured for preventing a lightning strike flashing to the heating layer. The electrical insulation layer 70 is interposed between the metallic lightning protection layer 60 and the heating layer 50. In the present embodiment, the electrical insulation layer 70 is made of laminate structure including a polyethylene terephthalate (PET) film sandwiched between two glass fibre layers. Other arrangements may also provide sufficient electrical insulation. The electrical insulation layer 70 comprises a longitudinal suction side edge 75 and a longitudinal pressure side edge 76. The longitudinal suction and pressure side edges 75, 76 of the electrical insulation layer 70 extend beyond and further towards the trailing edge (not shown in FIG. 4 but lies opposite of the leading edge 18) than both the longitudinal suction side edge 55 and the longitudinal pressure side edge 56 of the heating layer 50. In particular, the longitudinal suction side edge 75 of the electrical insulation layer 70 extends beyond a first plane P₁ intersecting the longitudinal suction side edge 55 of the heating layer 50 and the longitudinal suction side edge 65 of the metallic lightning protection layer 60. Correspondingly, the longitudinal pressure side edge 76 of the electrical insulation layer 70 extends beyond a second plane P₂ intersecting the longitudinal pressure side edge 56 of the heating layer 50 and the longitudinal pressure side edge 66 of the metallic lightning protection layer 60.

In the present embodiment as best seen in FIG. 3, the electro-thermal system 40 comprises three cable clamp devices 100. The cable clamp devices 100 electrically connect a shielding (not shown) of the power cable 90 with the down conductor 95 to form an equipotential bonding connection at distinct longitudinal positions along the longitudinal direction between the root end 17 and the tip end 15 of the blade 10.

The electro-thermal system 40 further comprises four first surge protection devices 110 and a single second surge protection device 111. The four first surge protection devices 110 are electrically connected to the heating layer 50 and the metallic lightning protection layer 60 and configured for preventing a surge current in the heating layer 50 when lightning strikes the wind turbine blade 10. The single second surge protection device is arranged between the down conductor 95 and the shielding of the power cable 90.

The electro-thermal system 40 further comprises an exterior temperature sensor 121 configured for sensing an exterior temperature of the wind turbine blade 10 and an interior temperature sensor 120 configured for sensing an interior temperature of the wind turbine blade 10. In some embodiments, the exterior temperature sensor 121 may be omitted. The temperature sensors 120, 121 are configured for providing temperature signals to a control device that can for instance be arranged in the nacelle 6 or hub 8 of the wind turbine 2. Such a control device may control the power supply to the heating layer 50 based on the temperature signals from the temperature sensors 120, 121 so as to mitigate ice formation on the wind turbine blade. The interior temperature sensor may be fibre-optic while the exterior temperature sensor may be wireless.

The arrangement shown in FIG. 4 is obtained by laying up the heating layer 50, the metallic lightning protection layer 60, and the electrical insulation layer 70 together with the remaining shell layers 27 (e.g. carbon or glass fibre layers and optionally core layer such as a foamed polymer or balsawood, however some parts, e.g. the main laminate 23, may be made from pultrusions such as carbon fibre pultrusions) of the aerodynamic shell body 21 as dry layers and subsequently infusing and curing the layers 50, 60, 70, 27 in a single vacuum assisted resin transfer moulding process together. Accordingly, the heating layer 50, the metallic lightning protection layer 60, and the electrical insulation layer 70 are embedded in and co-infused with the aerodynamic shell body 21.

As best seen in FIG. 4, the aerodynamic shell body 21 comprises a longitudinally extending bond line 28 between the suction side shell part 26 and the pressure side shell part 24. At the leading edge 18, the bond line 28 divides the heating layer 50 into a first heating layer part 51 and a second heating layer part 52, divides the metallic lightning protection layer 60 into a first metallic lightning protection layer part 61 and a second metallic lightning protection part 62, and divides the electrical insulation layer 70 into a first electrical insulation layer part 71 and a second electrical insulation layer part 72. The first heating layer part 51, the first metallic lightning protection layer part 61, and the first electrical insulation layer part 71 are embedded in and co-infused with the suction side shell part 26 while the second heating layer part 52, the second metallic lightning protection layer part 62, and the second electrical insulation layer part 72 are embedded in and co-infused with the pressure side shell part 24.

In order to electrically insulate the ends of the heating layer parts 51, 52 adjacent to the bond line 28, the electro-thermal system 40 comprises a leading edge insulation layer 80 made of an electrically insulating PET film. As shown in FIG. 4, the leading edge insulation layer 80 extend along and overlap the bond line 28 at the leading edge 18. The leading edge insulation layer has a longitudinal suction side edge 81 and a longitudinal pressure side edge 82 distanced from the bond line 28 along a circumference of the aerodynamic shell body 21. Thus, the leading edge insulation layer 80 extends transversely from the bond line 28 and overlaps the first and second metallic lightning protection layer parts 61, 62 along a circumference of the aerodynamic shell body 21 as best seen in FIG. 4.

As shown in FIG. 4, the aerodynamic shell body 21 comprises a leading edge protection cap 83 that overlaps the bond line 28 and the leading edge insulation layer 80. The leading edge protection cap 83 is configured for providing erosion resistance to the leading edge 18 of the wind turbine blade 10 and has an exterior side 84 that is exposed to the exterior of the wind turbine blade 10. The leading edge protection cap 83 consists essentially of polyurethane (PUR). The longitudinal suction and pressure side edge 81, 82 of the leading edge insulation layer 80 extends further towards the trailing edge (omitted on FIG. 4) than a longitudinal suction and pressure side edge of the leading edge protection cap 83, respectively. An edge sealing material is provided between the respective longitudinal suction side edges of the leading edge insulation layer 80 and the leading edge protection cap 83 and between the between the respective longitudinal pressure side edges of the leading edge insulation layer 80 and the leading edge protection cap 83. The edge sealing material is for smoothing the surface transition between the layers to reduce turbulence.

The electro-thermal system 40 further comprises a first exterior layer 85 covering the metallic lightning protection layer 60. The first exterior layer 85 has an interior side 87 facing and covering the metallic lightning protection layer 60 and has an exterior side 86 that is partly exposed to the exterior of the wind turbine blade 10 and partly covered by the leading edge protection cap 83. The first exterior layer is a polyurethane (PUR) paint and is relatively thin being in the range of 0.2-0.3 mm thick.

The aerodynamic shell body 21 comprises a second exterior layer 88 that has an exterior side 89 exposed to the exterior of the wind turbine blade 10. The second exterior layer 88 is substantially flush with the first exterior layer 85. The second exterior layer 88 does not cover the metallic lightning protection layer but instead the remaining exposed parts of the aerodynamic shell body 21. The second exterior layer 88 is formed of a different material than the first exterior layer 85. In the present embodiment, second exterior layer 88 is a polyester-based gelcoat.

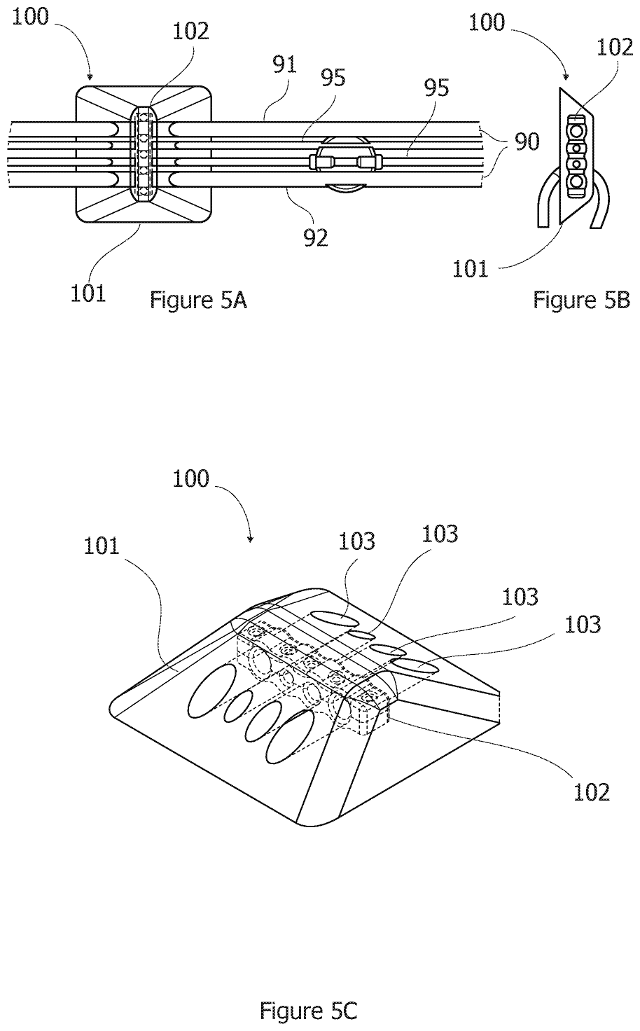

As best seen in FIG. 5A-5C, each cable clamp device 100 comprises a polymer housing 101 and a metallic clamp part 102. The metallic clamp part 102 receives and clamps the down conductor 95 and the shielding of the power conductors 91, 92 of the power cable 90 to form the equipotential bonding connection. The housing 101 surrounds the metallic clamp part 101 so as to electrically insulate the metallic clamp part 101 and the equipotential bonding connection. As best seen in FIG. 5C, the housing 101 comprises four through holes 103 accommodating the down conductor 95 and the power conductors 91, 92. In other embodiments, the housing 101 and metallic clamp part 102 may comprise three or even two through holes, such as when the electro-thermal system comprises a single down conductor 95 and a single power cable 90.

LIST OF REFERENCES

| | |
|---|---|
| 2 | wind turbine |
| 4 | tower |
| 6 | nacelle |
| 8 | hub |
| 10 | blade |
| 12 | shell |
| 14 | blade tip |
| 15 | tip end |
| 16 | blade root |
| 17 | root end |
| 18 | leading edge |
| 20 | trailing edge |
| 21 | aerodynamic shell body |
| 22 | leading edge section |
| 23 | main laminate |
| 24 | pressure side shell part |
| 26 | suction side shell part |
| 27 | shell layer |
| 28 | bond line |
| 30 | root region |
| 32 | transition region |
| 34 | airfoil region |
| 36 | tip region |
| 38 | shoulder |
| 40 | electro-thermal system |
| 50 | heating layer |
| 51 | first heating layer part |
| 52 | second heating layer part |
| 53 | root side edge |
| 54 | tip side edge |
| 55 | longitudinal suction side edge |
| 56 | longitudinal pressure side edge |
| 60 | metallic lightning protection layer |
| 61 | first metallic lightning protection layer part |
| 62 | second metallic lightning protection layer part |
| 63 | root side edge |
| 64 | tip side edge |
| 65 | longitudinal suction side edge |
| 66 | longitudinal pressure side edge |
| 70 | electrical insulation layer |
| 71 | first electrical insulation layer part |
| 72 | second electrical insulation layer part |
| 75 | longitudinal suction side edge |
| 76 | longitudinal pressure side edge |
| 80 | leading edge insulation layer |
| 81 | longitudinal suction side edge |
| 82 | longitudinal pressure side edge |
| 83 | leading edge protection cap |
| 84 | exterior side |
| 85 | first exterior layer |
| 86 | exterior side |
| 87 | interior side |
| 88 | second exterior layer |
| 89 | exterior side |
| 90 | power cable |
| 91 | first power conductor |
| 92 | second power conductor |
| 95 | down conductor |
| 96 | first end |
| 98 | tip receptor |
| 100 | cable clamp device |
| 101 | housing part |
| 102 | metallic clamp part |
| 103 | through hole |
| 110 | first surge protection device |
| 111 | second surge protection device |
| 112 | third surge protection device |
| 120 | interior temperature sensor |
| 121 | exterior temperature sensor |

1. A wind turbine blade (10) comprising:
an aerodynamic shell body (12) with a suction side shell part (22) and a pressure side shell part (24) that extends in a longitudinal direction (L) between a root (16) and a tip (14) and in a transverse direction between a leading edge (18) and a trailing edge (20), and
an electro-thermal system (40) for mitigating ice formation on the wind turbine blade, the electro-thermal system comprising:
a heating layer (50) comprising electrically conductive fibres arranged to extend substantially in a longitudinal section (19), preferably a leading edge section, of the aerodynamic shell body;
a power cable (90) configured for supplying power to the heating layer and configured for being connected to a power source, wherein the electrically conductive fibres of the heating layer are configured for, upon receiving electrical power from the power cable, supplying resistive heating to an exterior side of the wind turbine blade so as to mitigate, such as to melt or prevent, ice formation on the wind turbine blade;
a metallic lightning protection layer (60) arranged exteriorly to and overlapping the heating layer, the metallic lightning protection layer being configured for receiving a lightning strike; and
a down conductor (95) having a first end (96) arranged at the root of the wind turbine blade configured for being earthed, the down conductor being electrically connected to the metallic lightning protection layer so as to conduct a lightning strike current from the metallic lightning protection layer to the first end of the down conductor;
wherein the electrically conductive fibres of the heating layer and the metallic lightning protection layer are embedded in and co-infused with the aerodynamic shell body.

2. A wind turbine blade according to claim 1, wherein the electro-thermal system comprises an electrical insulation layer (70, 71, 72) interposed between the metallic lightning protection layer and the heating layer, the electrical insulation layer being configured for preventing a lightning strike flashing to the heating layer, wherein the electrical insulation layer is embedded in and co-infused with the aerodynamic shell body.

3. A wind turbine blade according to claim 2 wherein the electrical insulation layer comprises a laminate structure including a polymer film, e.g. a PET film, sandwiched between two glass fibre layers.

4. A wind turbine blade according to claim 1,
wherein the heating layer comprises a root side edge (53), a tip side edge (54), a longitudinal suction side edge (55), and a longitudinal pressure side edge (56),
wherein the metallic lightning protection layer comprises a root side edge (63), a tip side edge (64), a longitudinal suction side edge (65), and a longitudinal pressure side edge (66), and
wherein the tip edge side of the metallic lightning protection layer is positioned beyond the tip edge side of the heating layer towards the tip of the wind turbine blade.

5. A wind turbine blade according to claim 1, wherein the electrical insulation layer comprises a root side edge, a tip side edge, a longitudinal suction side edge (75), and a longitudinal pressure side edge (76),
wherein the longitudinal suction and pressure side edges of the electrical insulation layer extends beyond, e.g. further towards the trailing edge, both the longitudinal suction side edge and the longitudinal pressure side edge of the heating layer.

6. A wind turbine blade according to claim 5,
wherein the longitudinal suction side edge of the electrical insulation layer extends beyond a line or plane (P₁) intersecting the longitudinal suction side edge of the heating layer and the longitudinal suction side edge of the metallic lightning protection layer, and
wherein the longitudinal pressure side edge of the electrical insulation layer extends beyond a line or plane (P₂) intersecting the longitudinal pressure side edge of the heating layer and the longitudinal pressure side edge of the metallic lightning protection layer.

7. A wind turbine blade according to claim 1, wherein the aerodynamic shell body comprises a longitudinally extending bond line (26) between the suction side shell part and the pressure side shell part at the leading edge, the bond line dividing the heating layer into a first heating layer part (51) and a second heating layer part (52), the metallic lightning protection layer into a first metallic lightning protection layer part (61) and a second metallic lightning protection part (62),
wherein the first heating layer part and/or the first metallic lightning protection layer part are embedded in and co-infused with the suction side shell part, and
wherein the second heating layer part and/or the second metallic lightning protection layer part are embedded in and co-infused with the pressure side shell part.

8. A wind turbine blade according to claim 7, wherein the electro-thermal system comprises a leading edge insulation layer (80) made of an electrically insulating polymer material, wherein the leading edge insulation layer extends along and overlaps the bond line at the leading edge and extends transversely from the bond line and overlaps the first and second metallic lightning protection layer parts along a circumference of the suction side shell part and the pressure side shell part.

9. A wind turbine blade according to claim 7, wherein the aerodynamic shell body comprises a leading edge protection cap (84) overlapping the bond line, wherein the leading edge protection cap has an exterior side exposed to the exterior of the wind turbine blade and being configured for providing erosion resistance to the leading edge of the wind turbine blade.

10. A wind turbine blade according to claim 1, wherein the electro-thermal system comprises a first exterior layer (85) covering the metallic lightning protection layer, the first exterior layer having an interior side (87) covering the metallic lightning protection layer and an exterior side (86) exposed to the exterior of the wind turbine blade.

11. A wind turbine blade according to claim 1, wherein the aerodynamic shell body comprises a second exterior layer (88) having an exterior side (89) exposed to the exterior of the wind turbine blade, the second exterior layer being substantially flush with the first exterior layer and being different from the first exterior layer.

12. A wind turbine blade according to claim 1, wherein the electro-thermal system comprises a number of cable clamp devices (100) including at least a first cable clamp device, the number of cable clamp devices electrically connecting the power cable and the down conductor to form an equipotential bonding connection at distinct longitudinal positions along the longitudinal direction between the root and the tip of the blade.

13. A wind turbine blade according to claim 1, wherein the number of cable clamp devices each comprises a housing (101) and a metallic clamp part (102), wherein each metallic clamp part receive and clamp the down conductor and the power cable to form an equipotential bonding connection, and wherein the housing surrounds the metallic clamp part so as to electrically insulate the metallic clamp part and the equipotential bonding connection, and wherein the housing comprises through holes (103) accommodating the down conductor and the power cable.

14. A wind turbine blade according to claim 1, wherein the electro-thermal system comprises a number of surge protection devices (110, 111) including one or more first surge protection devices (110) and/or one or more second surge protection devices (111) and/or one or more third surge protection devices (112), wherein the first surge protection devices are connected to the heating layer and down conductor, the second surge protection devices are connected to the heating layer and the metallic lightning protection layer, and the third surge protection devices being connected to the down conductor and the power cable.

15. A wind turbine blade according to claim 1, wherein the electro-thermal system comprises a number of temperature sensors (120, 121) including at least one interior temperature sensor (120) configured for sensing an interior temperature of the wind turbine blade and/or at least one exterior temperature sensor (121) configured for sensing an exterior temperature of the wind turbine blade.

16. A method of manufacturing an aerodynamic shell body (21) for a wind turbine blade, the method comprising laying up a heating layer (50) comprising electrically conductive fibres, a metallic lightning protection layer (60), and an electrical insulation layer (70) together with one or more shell layers (27) as dry layers and subsequently co-infusing and curing the layers (27, 50, 60, 70), in a single vacuum assisted resin transfer moulding process so as to embed the heating layer (50), the metallic lightning protection layer (60), and the electrical insulation layer (70) in an aerodynamic shell body (21).
